(19) United States
(12) Patent Application Publication
(10) Pub. No.: US 2004/0028466 A1
(43) Pub. Date: Feb. 12, 2004

(54) Steel pipe connection device

(76) Inventor: Wei-Luen Tsai, Taichung (TW)

Correspondence Address: Wei-Luen Tsai, 58, MA YUAN WEST ST., TAICHUNG, TW

(21) Appl. No.: 10/216,475

(22) Filed: Aug. 6, 2002

(51) Int. Cl. F16B 7/08

(52) U.S. Cl. 403/231

(57) ABSTRACT

A steel pipe connection device has a steel pipe, a steel frame, the steel pipe having a U-shaped taper connector having a slot, and the steel frame having a taper insertion bar disposed on an end of the steel frame. The taper insertion bar has a taper insertion end. The taper insertion bar is inserted in the slot of the U-shaped taper connector.

### BACKGROUND OF THE INVENTION

The present invention relates to a steel pipe connection device. More particularly, the present invention relates to a steel pipe connection device which allows a large tolerance between a connector and an insertion bar.

Referring to FIG. 1, a conventional steel pipe connection device has a steel pipe 1, a steel frame 2, the steel pipe 1 having a U-shaped connector 11 having a slot 12, and the steel frame 2 having a downward insertion bar 21 inserted in the slot 12 of the U-shaped connector 11. Since the contact area between the U-shaped connector 11 and the downward insertion bar 21 is very small, the steel pipe 1 and the steel frame 2 cannot be connected stably. When the slot 12 of the U-shaped connector 11 is smaller than the downward insertion bar 21, the downward insertion bar 21 cannot be inserted in the slot 12 of the U-shaped connector 11.

### SUMMARY OF THE INVENTION

An object of the present invention is to provide a steel pipe connection device which allows a large tolerance between a connector and an insertion bar.

Another object of the present invention is to provide a steel pipe connection device which allows a large tolerance between a connector and an insertion rod.

In accordance with a first preferred embodiment of the present invention, a steel pipe connection device comprises a steel pipe, a steel frame, the steel pipe having a U-shaped taper connector having a slot, and the steel frame having a taper insertion bar disposed on an end of the steel frame. The taper insertion bar is inserted in the slot of the U-shaped taper connector.

In accordance with a second preferred embodiment of the present invention, a steel pipe connection device comprises a steel pipe, a steel frame, the steel pipe having a semicircular taper connector having a slot, and the steel frame having a taper insertion rod disposed on an end of the steel frame. The taper insertion rod is inserted in the slot of the semicircular taper connector.

### BRIEF DESCRIPTION OF THE DRAWINGS

FIG. 1 is a perspective exploded view of a steel pipe connection device of the prior art;

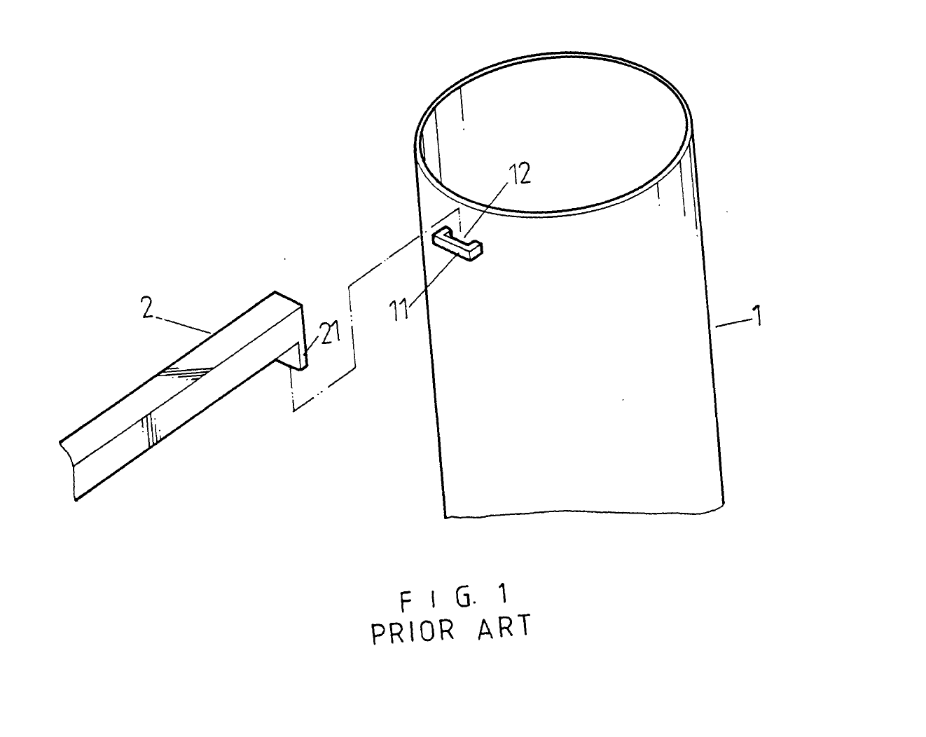

FIG. 2 is a perspective exploded view of a steel pipe connection device of a first preferred embodiment in accordance with the present invention;

FIG. 3 is a sectional assembly view of a steel pipe connection device of a first preferred embodiment in accordance with the present invention; and

FIG. 4 is a perspective exploded view of a steel pipe connection device of a second preferred embodiment in accordance with the present invention.

### DETAILED DESCRIPTION OF THE INVENTION

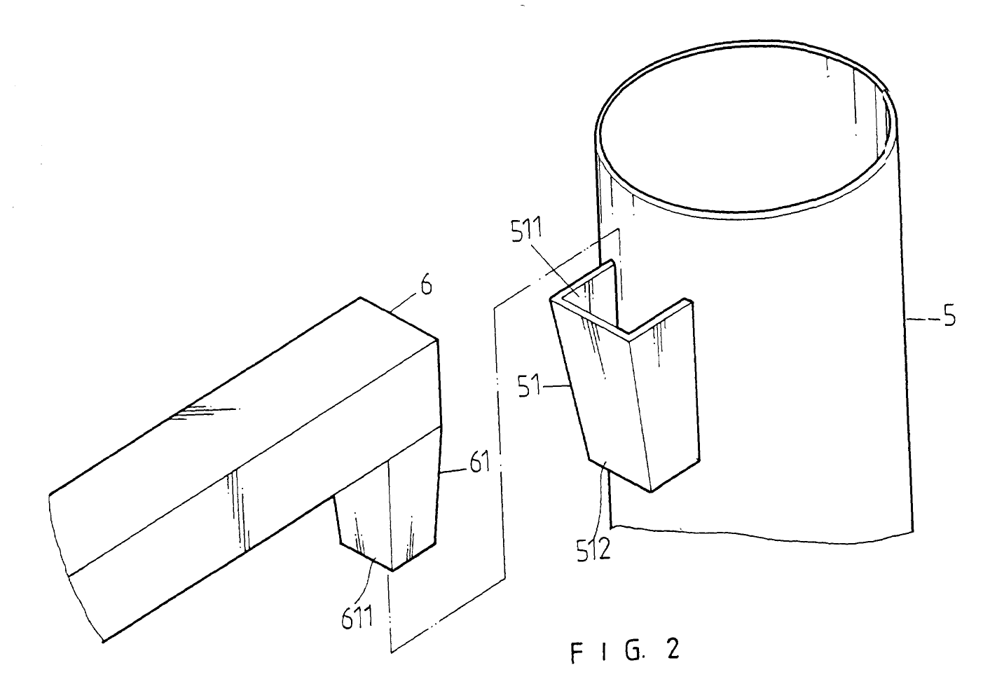

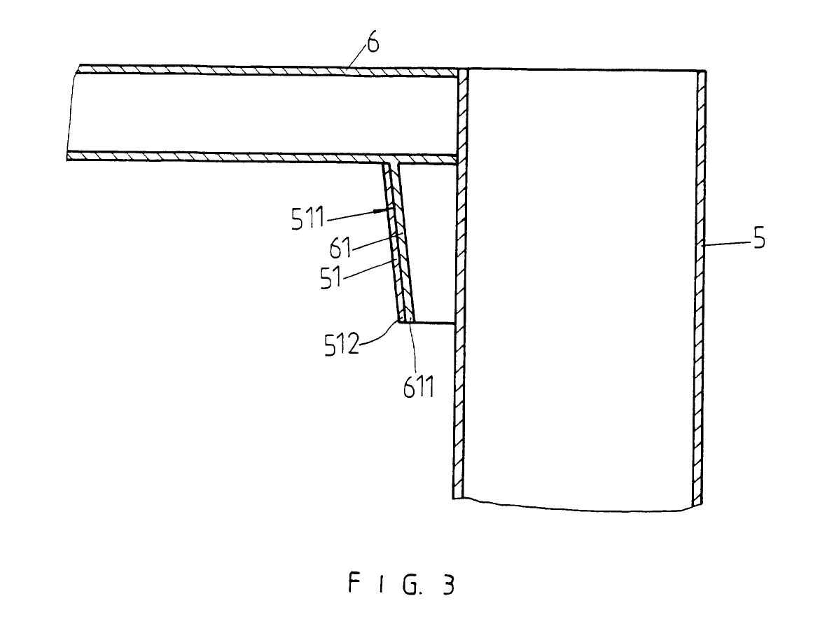

Referring to FIGS. 2 and 3, a first steel pipe connection device comprises a steel pipe 5, a steel frame 6, the steel pipe 5 having a U-shaped taper connector 51 having a slot 511, and the steel frame 6 having a taper insertion bar 61 disposed on an end of the steel frame 6. The taper insertion bar 61 has a taper insertion end 611. The taper insertion bar 61 is inserted in the slot 511 of the U-shaped taper connector 51.

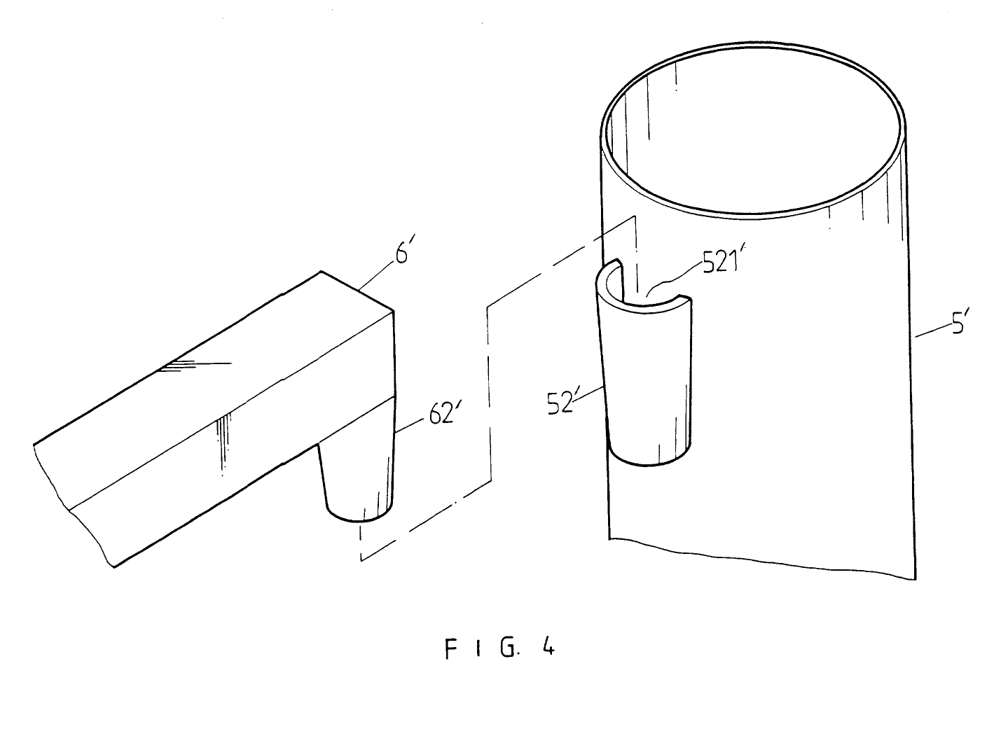

Referring to FIG. 4, a second steel pipe connection device comprises a steel pipe 5′, a steel frame 6′, the steel pipe 5′ having a semicircular taper connector 52′ having a slot 521′, and the steel frame 6′ having a taper insertion rod 62′ disposed on an end of the steel frame 6′. The taper insertion rod 62′ is inserted in the slot 521′ of the semicircular taper connector 52′.

The invention is not limited to the above embodiment but various modification thereof may be made. Further, various changes in form and detail may be made without departing from the scope of the invention.

I claim:

1. A steel pipe connection device comprises:
a steel pipe and a steel frame,
the steel pipe having a U-shaped taper connector having a slot,
the steel frame having a taper insertion bar disposed on an end of the steel frame, and
the taper insertion bar inserted in the slot of the U-shaped taper connector.

2. A steel pipe connection device comprises:
a steel pipe and a steel frame,
the steel pipe having a semicircular taper connector having a slot,
the steel frame having a taper insertion rod disposed on an end of the steel frame, and
the taper insertion rod inserted in the slot of the semicircular taper connector.
